(19) United States
(12) Patent Application Publication
(10) Pub. No.: US 2025/0253977 A1
(43) Pub. Date: Aug. 7, 2025

(54) APPARATUS AND METHOD FOR HARQ-ACK FEEDBACK FOR MULTICAST SERVICE

(71) Applicant: APPLE INC., Cupertino, CA (US)

(72) Inventors: Chunhai Yao, Beijing (CN); Oghenekome Oteri, San Diego, CA (US); Fangli Xu, Beijing (CN); Seyed Ali Akbar Fakoorian, San Diego, CA (US); Chunxuan Ye, San Diego, CA (US); Dawei Zhang, Saratoga, CA (US); Hong He, San Jose, CA (US); Yushu Zhang, Beijing (CN); Wei Zeng, San Diego, CA (US); Weidong Yang, San Diego, CA (US); Sigen Ye, San Diego, CA (US)

(21) Appl. No.: 18/857,705

(22) PCT Filed: Apr. 25, 2022
(86) PCT No.: PCT/CN2022/088917

§ 371 Date: Oct. 17, 2024

(51) Int. Cl. H04L 1/1812; H04L 5/00; H04W 8/22; H04W 72/231; H04W 76/28

(52) U.S. Cl. CPC H04L 1/1812; H04L 5/0053; H04W 8/22; H04W 72/231; H04W 76/28

(57) ABSTRACT

The disclosure relates to apparatus and method for supporting Hybrid Automatic Repeat request (HARQ)-Acknowledgement (ACK) feedback for multicast service. In some aspects, a user equipment (UE) device may comprise at least one antenna; at least one radio, coupled to the at least one antenna and configured to perform wireless communication using at least one radio access technology; and one or more processors coupled to the at least one radio, wherein the one or more processors are configured to cause the UE device to: receive, from a base station, a Radio Resource Control (RRC) signaling which indicates that a semi-static codebook is configured for a Hybrid Automatic Repeat Request (HARQ)-Acknowledgement (ACK) feedback for both multicast and unicast and that a HARQ-ACK feedback for multicast is disabled; and generate a HARQ-ACK feedback report which excludes a HARQ-ACK bit for the multicast by using a time domain resource assignment (TDRA) for the unicast to configure the semi-static codebook.

### TECHNICAL FIELD

This application relates generally to wireless communication systems, including apparatus and method for supporting Hybrid Automatic Repeat request (HARQ)-Acknowledgement (ACK) feedback for multicast service.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

The NR may support Multicast and Broadcast Services (MBS) for UEs. Accordingly, an uplink (UL) feedback, for example, HARQ-ACK feedback is required to improve the reliability of MBS. The level of reliability may be based on the requirements of the application/service provided. The HARQ-ACK feedback may generally comprise Non-Acknowledge (NACK) only based feedback and Acknowledge (ACK)/Non-Acknowledge (NACK) based feedback. For the Multicast service, both NACK only based feedback and ACK/NACK based feedback are proposed to be supported in order to improve the multicast physical downlink shared channel (PDSCH) reception reliability. Thus, there is a need for techniques for supporting HARQ-ACK feedback for multicast service.

### SUMMARY

In some aspects, a user equipment (UE) device may comprise at least one antenna; at least one radio, coupled to the at least one antenna and configured to perform wireless communication using at least one radio access technology; and one or more processors coupled to the at least one radio, wherein the one or more processors are configured to cause the UE device to: receive, from a base station, a Radio Resource Control (RRC) signaling which indicates that a semi-static codebook is configured for a Hybrid Automatic Repeat Request (HARQ)-Acknowledgement (ACK) feedback for both multicast and unicast and that a HARQ-ACK feedback for multicast is disabled; and generate a HARQ-ACK feedback report which excludes a HARQ-ACK bit for the multicast by using a time domain resource assignment (TDRA) for the unicast to configure the semi-static codebook.

In some aspects, a user equipment (UE) device may comprise at least one antenna; at least one radio, coupled to the at least one antenna and configured to perform wireless communication using at least one radio access technology; and one or more processors coupled to the at least one radio, wherein the one or more processors are configured to cause the UE device to: receive, from a base station, a Radio Resource Control (RRC) signaling which indicates that a semi-static codebook is configured for a Hybrid Automatic Repeat Request (HARQ)-Acknowledgement (ACK) feedback for both multicast and unicast; receive, from the base station, Downlink Control Information (DCI) which indicates that a HARQ-ACK feedback for multicast is disabled; and generate an HARQ-ACK feedback report which includes an ACK/Non-Acknowledge (NACK) based HARQ-ACK bit for the multicast or a NACK only based HARQ-ACK bit for the multicast in the semi-static codebook configured by using an actual ACK or NACK feedback.

In some aspects, a user equipment (UE) device may comprise: at least one antenna; at least one radio coupled to the at least one antenna and configured to perform wireless communication using at least one radio access technology; and one or more processors coupled to the at least one radio, wherein the one or more processors are configured to cause the UE device to: receive, from a base station, a Radio Resource Control (RRC) signaling which indicates that a semi-static codebook is configured for a Hybrid Automatic Repeat Request (HARQ)-Acknowledgement (ACK) feedback for multicast; receive, from the base station, Downlink Control Information (DCI) which indicates that a HARQ-ACK feedback for multicast is not disabled when the semi-static codebook is configured via an indication field for HARQ-ACK feedback for multicast; and generate an HARQ-ACK feedback report which includes an HARQ-ACK bit for the multicast.

In some aspects, a user equipment (UE) device may comprise at least one antenna; at least one radio, coupled to the at least one antenna and configured to perform wireless communication using at least one radio access technology; and one or more processors coupled to the at least one radio, wherein the one or more processors are configured to cause the UE device to: determine that the UE device supports an Acknowledgement (ACK)/Non-Acknowledge (NACK) based Hybrid Automatic Repeat Request (HARQ) feedback for multicast dynamic scheduling and for multicast Semi-Persistent Scheduling (SPS); receive, from a base station, a Radio Resource Control (RRC) signaling which indicates that a semi-static codebook is configured for the ACK-NACK based HARQ feedback for multicast dynamic scheduling and that the ACK-NACK based HARQ feedback for multicast SPS is disabled; and generate a HARQ-ACK feedback report which excludes a HARQ-ACK bit for the multicast SPS by using a time domain resource assignment (TDRA) for multicast to configure the semi-static codebook.

In some aspects, a user equipment (UE) device may comprise at least one antenna; at least one radio, coupled to the at least one antenna and configured to perform wireless communication using at least one radio access technology; and one or more processors coupled to the at least one radio, wherein the one or more processors are configured to cause the UE device to: determine that the UE device supports an Acknowledgement (ACK)/Non-Acknowledge (NACK) based Hybrid Automatic Repeat Request (HARQ) feedback for multicast dynamic scheduling and for multicast Semi-Persistent Scheduling (SPS); receive, from a base station, a Radio Resource Control (RRC) signaling which indicates that a semi-static codebook is configured for the ACK-NACK based HARQ feedback for the multicast SPS and that the ACK-NACK based HARQ feedback for multicast dynamic scheduling is disabled; determine whether a unicast Physical Downlink Shared Channel (PDSCH) is received; and in response to determining that no unicast PDSCH is received, generate a HARQ-ACK feedback report which includes only HARQ-ACK bits for the multicast SPS.

In some aspects, a user equipment (UE) device may comprise at least one antenna; at least one radio, coupled to the at least one antenna and configured to perform wireless communication using at least one radio access technology; and one or more processors coupled to the at least one radio, wherein the one or more processors are configured to cause the UE device to: determine that the UE device supports an Acknowledgement (ACK)/Non-Acknowledge (NACK) based Hybrid Automatic Repeat Request (HARQ) feedback for multicast dynamic scheduling and for multicast Semi-Persistent Scheduling (SPS); receive, from a base station, a Radio Resource Control (RRC) signaling which indicates that a semi-static codebook is configured for a HARQ-ACK feedback for multicast; receive, from the base station, Downlink Control Information (DCI) which indicates that either the ACK-NACK based HARQ feedback for multicast dynamic scheduling or the ACK-NACK based HARQ feedback for multicast SPS is disabled; and generate an HARQ-ACK feedback report which includes ACK/NACK based HARQ bits for the multicast dynamic scheduling and for the multicast SPS in the semi-static codebook configured by using an actual ACK or NACK feedback.

In some aspects, a user equipment (UE) device may comprise: at least one antenna; at least one radio coupled to the at least one antenna and configured to perform wireless communication using at least one radio access technology; and one or more processors coupled to the at least one radio, wherein the one or more processors are configured to cause the UE device to: determine that the UE device supports an Acknowledgement (ACK)/Non-Acknowledge (NACK) based Hybrid Automatic Repeat Request (HARQ) feedback for multicast dynamic scheduling and for multicast Semi-Persistent Scheduling (SPS); and receive, from a base station, message which indicates that the ACK/NACK based HARQ feedback for multicast dynamic scheduling and the ACK/NACK based HARQ feedback for multicast SPS as both enabled or both disabled.

In some aspects, A user equipment (UE) device may comprise: at least one antenna; at least one radio, coupled to the at least one antenna and configured to perform wireless communication using at least one radio access technology; and one or more processors coupled to the at least one radio, wherein the one or more processors are configured to cause the UE device to: report to a base station the UE device's capability that supports an operating mode of transforming Non-Acknowledge (NACK) only based Hybrid Automatic Repeat Request (HARQ) feedback bits into Acknowledgement (ACK)/NACK based HARQ feedback bits to support more than one bit for the NACK only based HARQ feedback for multicast; receive from the base station information on a codebook type for the NACK only based HARQ feedback for multicast configured for the operating mode; and construct a codebook for the NACK only based HARQ feedback for multicast in a same way as a codebook for the ACK/NACK based HARQ feedback for multicast according to the configured codebook type.

In some aspects, A user equipment (UE) device may comprise: at least one antenna; at least one radio, coupled to the at least one antenna and configured to perform wireless communication using at least one radio access technology; and one or more processors coupled to the at least one radio, wherein the one or more processors are configured to cause the UE device to: report to a base station the UE device's capability that supports an operating mode of a using a predefined mapping rule which defines mapping between one or more Hybrid Automatic Repeat Request (HARQ) feedback bits for respective received one or more Transport Blocks (TBs) and a plurality of Physical Uplink Control Channel (PUCCH) resource sets to support more than one bit for Non-Acknowledge (NACK) only based HARQ feedback for multicast; receive, from the base station, a Radio Resource Control (RRC) signaling which indicates a PUCCH configuration for the NACK only based HARQ feedback for multicast; generate an HARQ feedback report which includes HARQ feedback bits comprising an ACK or NACK bit for each scheduled TB; select a PUCCH resource set from the plurality of PUCCH resource sets according to the predefined mapping rule, wherein for a particular PUCCH resource set in the predefined mapping rule, if one more TB is scheduled, a NACK bit is appended on top of one or more existing HARQ feedback bits; and transmit the HARQ feedback report using the selected PUCCH resource set.

The techniques described herein may be implemented in and/or used with a number of different types of devices, including but not limited to cellular base stations, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to aspects disclosed herein.

FIG. 2 illustrates a system for performing signaling between a wireless device and a network device, according to aspects disclosed herein.

FIG. 3 is a flowchart diagram illustrating a first example method for generating an HARQ-ACK feedback report, by a UE device, according to aspects disclosed herein.

FIG. 4 is a flowchart diagram illustrating a second example method for generating an HARQ-ACK feedback report, by a UE device, according to aspects disclosed herein.

FIG. 5 is a flowchart diagram illustrating a third example method for generating an HARQ-ACK feedback report, by a UE device, according to aspects disclosed herein.

FIG. 6 is a flowchart diagram illustrating a fourth example method for generating an HARQ-ACK feedback report, by a UE device, according to aspects disclosed herein.

FIG. 7 is a flowchart diagram illustrating a fifth example method for generating an HARQ-ACK feedback report, by a UE device, according to aspects disclosed herein.

FIG. 8 is a flowchart diagram illustrating a sixth example method for generating an HARQ-ACK feedback report, by a UE device, according to aspects disclosed herein.

FIG. 9 is a flowchart diagram illustrating a seventh example method for determining configuration of a HARQ-ACK feedback for multicast, by a UE device, according to aspects disclosed herein.

FIG. 10 is a flowchart diagram illustrating an eighth example method for constructing a codebook, by a UE device, according to aspects disclosed herein.

FIG. 11 is a flowchart diagram illustrating a ninth example method for transmitting a HARQ-ACK feedback report, by a UE device, according to aspects disclosed herein.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component. Examples of a UE may include a mobile device, a personal digital assistant (PDA), a tablet computer, a laptop computer, a personal computer, an Internet of Things (IoT) device, or a machine type communications (MTC) device, among other examples, which may be implemented in various objects such as appliances, or vehicles, meters, among other examples.

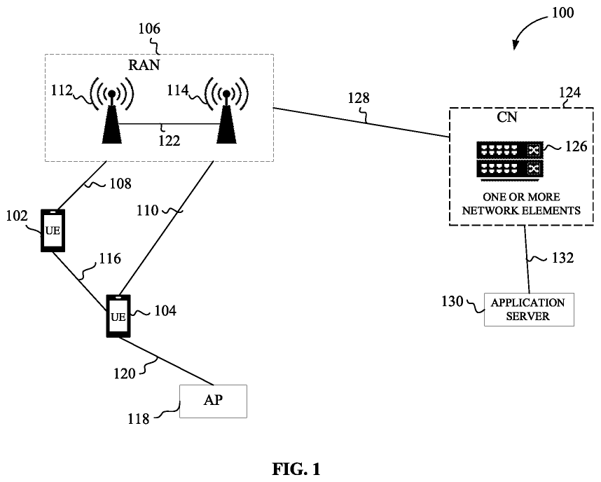

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

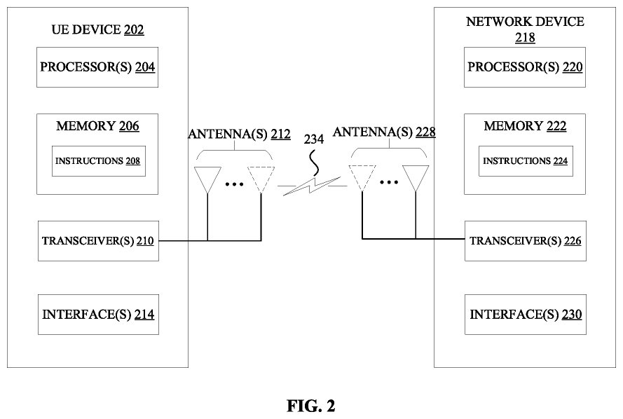

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

### Type-1 HARQ-ACK Feedback Codebook Construction if HARQ-ACK Feedback for Multicast is Disabled

A BS may notify a UE of the codebook type for ACK/NACK based HARQ feedback for multicast via a RRC parameter pdsch-HARQ-ACK-Codebook-Multicast. There are two codebook types: semi-static codebook which is also called Type-1 codebook and dynamic codebook which is also called Type-2 codebook. UE may be configured with pdsch-HARQ-ACK-Codebook or pdsch-HARQ-ACK-CodebookList. This configuration is applied to all Group-Radio Network Temporary Identifier (G-RNTI) configured to the UE.

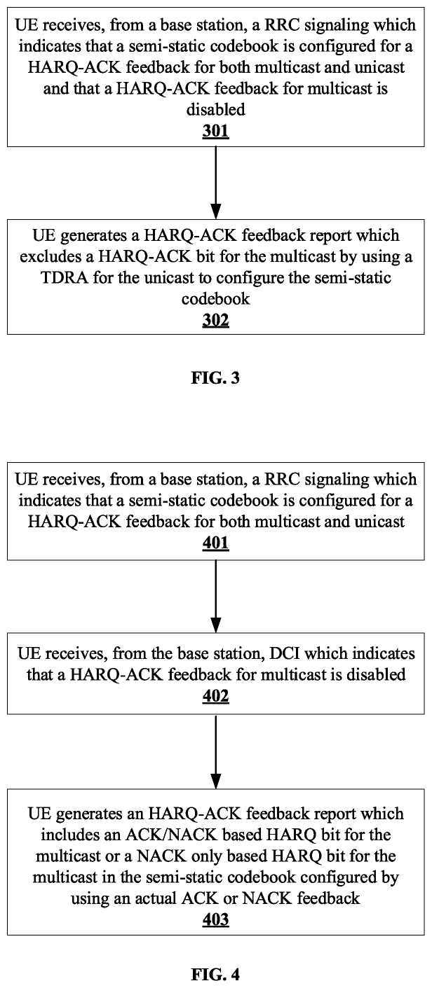

The HARQ-ACK feedback for multicast can be enabled or disabled by RRC signaling or by Downlink Control Information (DCI) dynamically per G-RNTI. FIG. 3 ang FIG. 4 illustrate how a UE device constructs Type-1 HARQ-ACK feedback codebook when the HARQ-ACK feedback for multicast is disabled by RRC signaling and by DCI, respectively.

FIG. 3 is a flowchart diagram illustrating a first example method for generating an HARQ-ACK feedback report when the HARQ-ACK feedback for multicast is disabled by RRC signaling, by a UE device, according to aspects disclosed herein.

At 301, the UE device may receive, from a base station, a RRC signalling which indicates that a semi-static codebook is configured for a HARQ-ACK feedback for both multicast and unicast. The RRC signalling also indicates that a HARQ-ACK feedback for multicast is disabled.

At 302, the UE device may generate a HARQ-ACK feedback report which excludes a HARQ-ACK bit for the multicast by using a time domain resource assignment (TDRA) for the unicast to configure the semi-static codebook. Thus, the UE device removes the HARQ-ACK bit for multicast from the HARQ-ACK feedback report, and then uses the TDRA table for unicast to determine the Type-1 codebook size, thereby constructing the Type-1 HARQ-ACK feedback codebook.

FIG. 4 is a flowchart diagram illustrating a second example method for generating an HARQ-ACK feedback report when the HARQ-ACK feedback for multicast is disabled by DCI, by a UE device, according to aspects disclosed herein.

At 401, the UE device may receive, from a BS, a RRC signaling which indicates that a semi-static codebook is configured for a HARQ-ACK feedback for both multicast and unicast.

At 402, the UE device may receive, from the BS, DCI which indicates that a HARQ-ACK feedback for multicast is disabled. The DCI may be a DCI format 4_2 which is specialized for multicast service.

At 403, the UE device may generate an HARQ-ACK feedback report which includes HARQ-ACK feedback bit for the multicast in the semi-static codebook configured with an actual ACK or NACK feedback. The HARQ-ACK feedback may be an ACK/NACK based HARQ feedback or a NACK only based HARQ feedback.

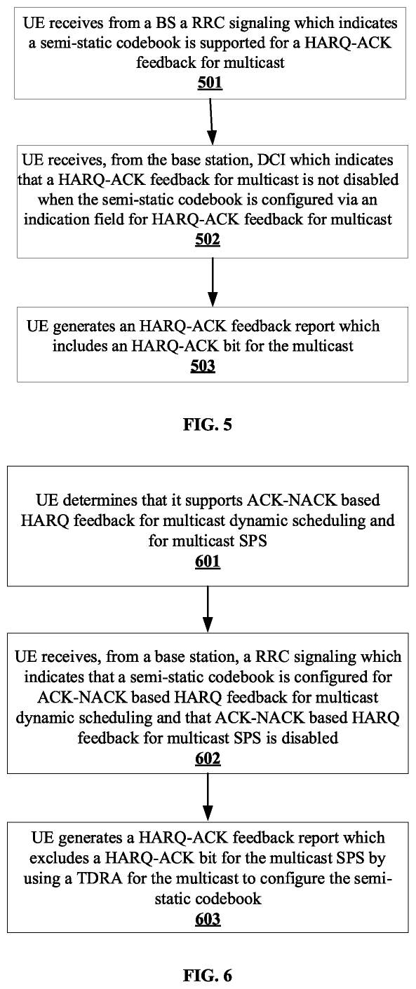

FIG. 5 is a flowchart diagram illustrating a third example method for generating an HARQ-ACK feedback report according to DCI received from a BS, by a UE device, according to aspects disclosed herein.

At 501, UE may receive, from a BS, a RRC signalling which indicates that a semi-static codebook is configured for a HARQ-ACK feedback for both multicast.

At 502, UE may receive, from the BS, DCI which indicates that a HARQ-ACK feedback for multicast is not disabled when the semi-static codebook is configured, via an indication field for HARQ-ACK feedback for multicast.

The DCI, e.g., DCI format 4_2 may include an enabling/disabling HARQ-ACK feedback indication field which may indicate whether the HARQ-ACK feedback for multicast is enabled or disabled. The enabling/disabling HARQ-ACK feedback indication field includes 1 bit if a higher layer parameter harq-FeedbackEnabler Multicast indicates dci-enabler; otherwise it is 0 bit.

In some aspects, if Type-1 HARQ-ACK codebook is configured, UE may not expect that the enabling/disabling HARQ-ACK feedback indication field in the DCI format indicates disabled. In other words, the BS shall configure the HARQ-ACK feedback indication field as only enabled.

In other aspects, the enabling/disabling HARQ-ACK feedback indication field is only applied to Type-2 codebook for multicast. That is to say, the enabling/disabling HARQ-ACK feedback indication field can be configured to indicate enable or disable for Type-2 codebook for multicast. However, for Type-1 HARQ-ACK codebook, the BS shall not configure/include the HARQ-ACK feedback indication field in DCI.

At 503, UE may generate an HARQ-ACK feedback report which includes an HARQ-ACK bit for the multicast.

Type-1 HARQ-ACK feedback codebook construction for multiplexing multicast dynamic scheduling and multicast SPS

Multicast downlink scheduling may include multicast dynamic scheduling and multicast semi-persistent scheduling (SPS). Unlike dynamical scheduling which allocates radio resources to a UE every transmission time interval (TTI), SPS allows to semi-statically configure radio resources and periodically allocate the resources to the UE. Currently, HARQ-ACK enabling/disabling for multicast dynamic scheduling and for multicast Semi-Persistent Scheduling (SPS) are separate UE feature. Thus, HARQ-ACK feedback for multicast dynamic scheduling and multicast SPS can be enabled/disabled separately. FIGS. 6-9 illustrate operations of UE or BS in various scenarios where HARQ-ACK feedback for multicast dynamic scheduling or multicast SPS is enabled or disabled via RRC signaling or DCI.

FIG. 6 is a flowchart diagram illustrating a fourth example method for generating an HARQ-ACK feedback report when the ACK-NACK based HARQ feedback for multicast SPS is disabled via a RRC signaling, by a UE device, according to aspects disclosed herein.

At 601, UE may determine that it supports an ACK-NACK based HARQ feedback for multicast dynamic scheduling and for multicast SPS.

At 602, UE may receive, from a BS, a RRC signaling which indicates that a semi-static codebook is configured for ACK-NACK based HARQ feedback for multicast dynamic scheduling and that ACK-NACK based HARQ feedback for multicast SPS is disabled.

At 603, UE may generate a HARQ-ACK feedback report which excludes a HARQ-ACK bit for the multicast SPS by using a TDRA for multicast to configure the semi-static codebook. Thus, the UE device removes the HARQ-ACK bit for multicast SPS from the HARQ-ACK feedback report, and then uses the TDRA table for multicast to determine the Type-1 codebook size, thereby constructing the Type-1 HARQ-ACK feedback codebook.

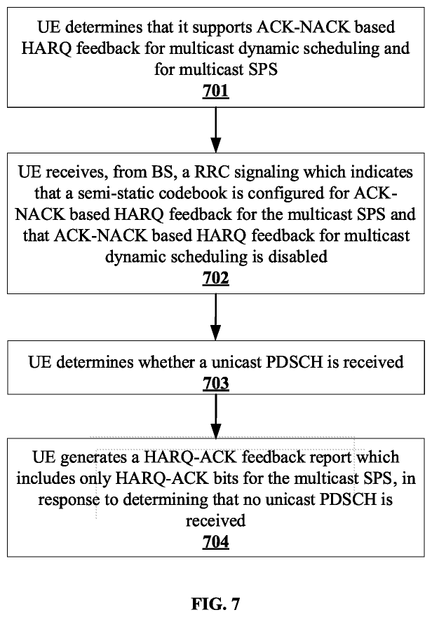

FIG. 7 is a flowchart diagram illustrating a fifth example method for generating an HARQ-ACK feedback report when the ACK-NACK based HARQ feedback for multicast dynamic scheduling is disabled via a RRC signaling, by a UE device, according to aspects disclosed herein.

At 701, UE may determine that the UE device supports an ACK-NACK based HARQ feedback for multicast dynamic scheduling and for multicast SPS.

At 702, UE may receive, from BS, a RRC signaling which indicates that a semi-static codebook is configured for ACK-NACK based HARQ feedback for the multicast SPS and that ACK-NACK based HARQ feedback for multicast dynamic scheduling is disabled.

At 703, UE may determine whether a unicast PDSCH is received.

At 704, in response to determining that no unicast PDSCH is received, UE may generate a HARQ-ACK feedback report which includes only HARQ-ACK bits for the multicast SPS. That is to say, a fallback operation for the Type-1 HARQ-ACK codebook occurs.

If a unicast PDSCH is received, a fallback operation for the Type-1 HARQ-ACK codebook also occurs.

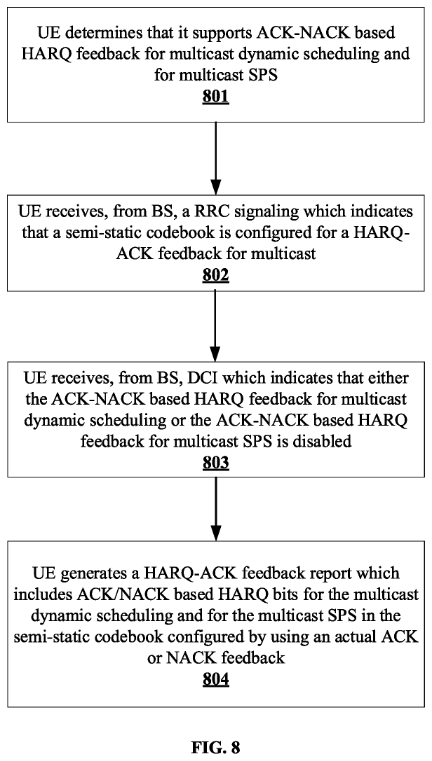

FIG. 8 is a flowchart diagram illustrating a sixth example method for generating an HARQ-ACK feedback report, when the ACK-NACK based HARQ feedback for multicast dynamic scheduling or for multicast SPS is disabled via DCI, by a UE device, according to aspects disclosed herein.

At 801, UE may determine that it supports ACK-NACK based HARQ feedback for multicast dynamic scheduling and for multicast SPS.

At 802, UE may receive, from a BS, a RRC signaling which indicates that a semi-static codebook is configured for a HARQ-ACK feedback for multicast.

At 803, UE may receive, from the BS, DCI which indicates that either the ACK-NACK based HARQ feedback for multicast dynamic scheduling or the ACK-NACK based HARQ feedback for multicast SPS is disabled.

At 804, UE may generate an HARQ feedback report which includes ACK/NACK based HARQ bits or NACK only based HARQ bits for the multicast dynamic scheduling and for the multicast SPS in the semi-static codebook configured by using an actual ACK or NACK feedback.

In particular, if the ACK-NACK based HARQ feedback for multicast SPS is disabled via DCI in SPS activation, the HARQ-ACK, i.e., ACK or NACK, for SPS is still generated in the codebook. Alternatively, NACK only based HARQ bit for SPS is generated.

If the ACK-NACK based HARQ feedback for multicast dynamic scheduling is disabled via DCI, the codebook construction is the same as when the feedback mode is ACK/NACK based HARQ feedback. That is to say, ACK/NACK based HARQ bits for the multicast dynamic scheduling are configured in the semi-static codebook by using an actual ACK or NACK feedback.

The above aspects discuss various scenarios where HARQ-ACK feedback for multicast dynamic scheduling or for multicast SPS is disabled. However, according to other aspects, UE may not expect that the multicast dynamic scheduled PDSCH and multicast SPS PDSCH have different enable/disable configuration.

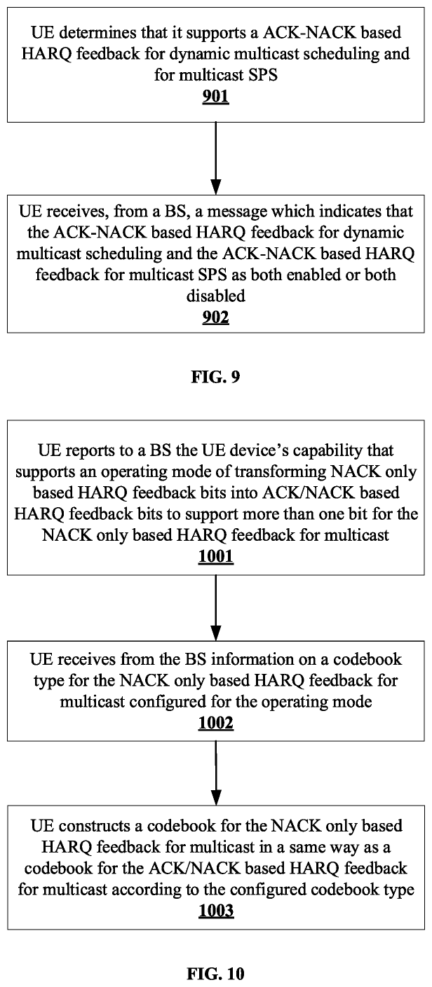

FIG. 9 is a flowchart diagram illustrating a seventh example method for determining configuration of a HARQ-ACK feedback for multicast, by a UE device, according to aspects disclosed herein.

At 901, UE may determine that it supports an ACK/NACK based HARQ feedback for multicast dynamic scheduling and for multicast SPS.

At 902, UE may receive, from a BS, a message which indicates that the ACK-NACK based HARQ feedback for dynamic multicast scheduling and the ACK-NACK based HARQ feedback for multicast SPS as both enabled or both disabled.

More than One Bit for NACK-Only Based HARQ-ACK Feedback

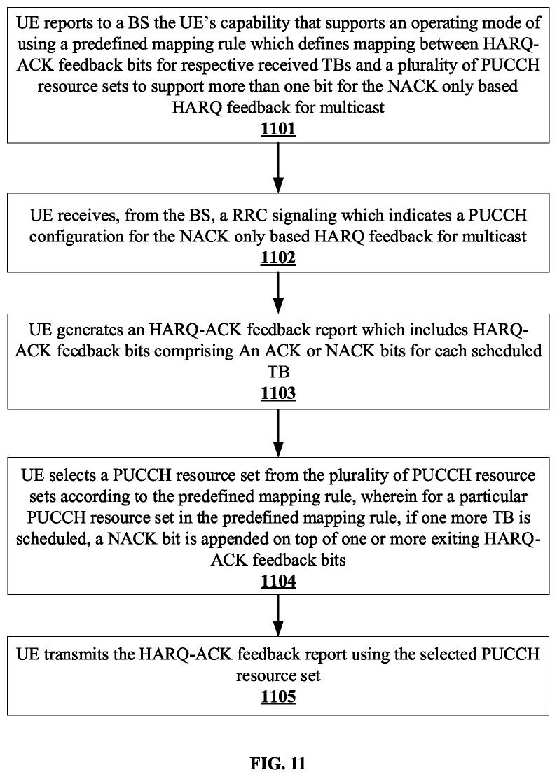

Normally only one bit will be reported for NACK-only based feedback and the Physical Uplink Control Channel (PUCCH) resource is shared among users. There has been proposed to support more than one NACK-only HARQ-ACK feedback for multicast in the same PUCCH transmission. Two operating modes for supporting more than one bit for NACK-only based HARQ-ACK feedback are discussed below: one is transforming NACK-only based HARQ bits into ACK/NACK based HARQ bits, and the other is using a predefined mapping rule which maps NACK-only based HARQ bits with PUCCH resource sets. The operating mode(s) to be used for UE is signaled via a RRC message. FIG. 10 and FIG. 11 illustrate the operations of UE in either of the two modes.

FIG. 10 is a flowchart diagram illustrating an eighth example method for constructing a codebook, by a UE device, according to aspects disclosed herein.

At 1001, UE may report, to a BS, the UE device's capability that supports an operating mode of transforming NACK only based HARQ feedback bits into ACK/NACK based HARQ feedback bits to support more than one bit for the NACK only based HARQ feedback for multicast.

At 1002, UE may receive from the BS, information on a codebook type for the NACK only based HARQ feedback for multicast configured for the operating mode.

The codebook type may be configured according to various strategies.

As option 1, a Type-1 codebook or a Type-2 codebook may be selectively determined for the NACK only based HARQ feedback for multicast.

As option 2, the codebook type for the NACK only based HARQ feedback for multicast may be determined by following the codebook type for the ACK/NACK based HARQ feedback for multicast having a same priority, if it is configured. Two priority indexes are introduced for multicast in DCI format 4_2, where index0 indicates low priority and index1 indicates high priority.

As option 3, the codebook type for the NACK only based HARQ feedback for multicast may be determined by following the codebook type for an HARQ-ACK feedback for unicast PDSCH having a same priority.

As option 4, the codebook type for the NACK only based HARQ feedback for multicast may be determined by combining the above options 1, 2 or 3.

As option 5, UE may assume the Type-2 codebook will be applied in case of the mode of transforming NACK-only based HARQ bits into ACK/NACK based HARQ bits. In other words, UE may not need receive information on the codebook type for the NACK only based HARQ feedback for multicast from BS.

At 1003, UE may construct a codebook for the NACK only based HARQ feedback for multicast in a same way as a codebook for the ACK/NACK based HARQ feedback for multicast according to the configured codebook type.

Generally, PUCCH resources for the NACK-only based HARQ feedback for multicast are shared among the users to be configured with the same G-RNTI. Now that the NACK-only based HARQ feedback falls back to ACK/NACK based HARQ feedback, UE needs to adaptively determine PUCCH resource to be used for transmitting the constructed codebook.

According to some aspects, UE may receive from the BS configuration of PUCCH resource which includes two PUCCH resource sets for UE use: first PUCCH resource set is for NACK-only based HARQ feedback for multicast, and second PUCCH resource set is for ACK/NACK based HARQ feedback for multicast. The DCI received by UE may include a PUCCH resource indicator (PRI) which may indicate the PUCCH resource of the second PUCCH resource set, if there are more than one bit for the NACK-only based HARQ feedback for multicast, and is reserved, if there is one bit for the NACK-only based HARQ feedback for multicast. Thus, the transformed ACK/NACK based HARQ feedback may be transmitted using the second PUCCH resource set by UE.

According to other aspects, BS may not configure the PUCCH resource set dedicated for NACK-only based HARQ feedback for multicast. Instead, UE may use the PUCCH resource for ACK/NACK based HARQ feedback for NACK-only based HARQ feedback. In this case, UE may receive a separate PUCCH-Config/PUCCH-ConfigurationList for NACK-only based HARQ feedback for multicast, or receive a RRC signaling including PUCCH configuration for ACK/NACK based HARQ feedback for multicast if it's configured. The PUCCH configuration for ACK/NACK based HARQ feedback for multicast may be signaled via a RRC parameter pucch-Config-Multicast1 which indicates PUCCH configuration for ACK/NACK based HARQ-ACK feedback for multicast for one Bandwidth Part (BWP) of the normal UL or supplementary uplink (SUL) of a serving cell.

According to yet other aspects, BS may not configure the PUCCH resource set dedicated for NACK-only based HARQ feedback for multicast. Instead, UE may use a PUCCH configuration for unicast for NACK only based HARQ feedback for multicast.

FIG. 11 is a flowchart diagram illustrating a ninth example method for transmitting a HARQ-ACK feedback report when the operating mode of using a predefined mapping rule of NACK-only based HARQ bits with PUCCH resource sets is applied, by a UE device, according to aspects disclosed herein.

At 1101, UE may report to a BS the UE's capability that supports an operating mode of using a predefined mapping rule which defines mapping between HARQ-ACK feedback bits for respective received TBs and a plurality of PUCCH resource sets to support more than one bit for the NACK only based HARQ feedback for multicast.

At 1102, UE may receive, from the BS, a RRC signaling which indicates a PUCCH configuration for the NACK only based HARQ feedback for multicast. For example, UE may receive a RRC parameter pucch-Config-Multicast2 which indicates PUCCH configuration for NACK-only based HARQ-ACK feedback for multicast for one BWP of the normal UL or SUL of a serving cell. It is UE specific and configured per UL BWP.

At 1103, UE may generate an HARQ feedback report which includes HARQ feedback bits comprising an ACK or NACK bit for each scheduled TB. For example, if only one TB, e.g., TB1 is transmitted by BS, the UE will feedback NACK if it does not receive TB1 and will not feedback ACK if it receives TB1. In other words, UE performs a NACK-only based HARQ-ACK feedback. But if two TBs, e.g., TB1 and TB2 are transmitted by BS, there are three combinations of feedback bits, i.e., (N,N), (N,A) and (A,N). They still belong to the NACK-only based HARQ-ACK feedback even if there is ACK.

At 1104, UE may select a PUCCH resource set from the plurality of PUCCH resource sets according to the predefined mapping rule. For a same PUCCH resource set in the predefined mapping rule, if one more TB is scheduled, a NACK bit is appended on top of one or more existing HARQ feedback bits. The following Table 1 illustrates an example of the predefined mapping rule.

TABLE 1

| HARQ-ACK feedback | | | | |
|---|---|---|---|---|
| | | | TB1, TB2, | PUCCH |
| TB1 | TB1, TB2 | TB1, TB2, TB3 | TB3, TB4 | resource |
| N | N, N | N, N, N | N, N, N, N | 1^{st} PUCCH |
| | | | | resource |
| | N, A | N, A, N | N, A, N, N | 2^{nd} PUCCH |
| | | | | resource |
| | A, N | A, N, N | A, N, N, N | 3^{rd} PUCCH |
| | | | | resource |
| | | N, N, A | N, N, A, N | 4^{th} PUCCH |
| | | | | resource |
| | | N, A, A | N, A, A, N | 5^{th} PUCCH |
| | | | | resource |
| | | A, N, A | A, N, A, N | 6^{th} PUCCH |
| | | | | resource |
| | | A, A, N | A, A, N, N | 7^{th} PUCCH |
| | | | | resource |
| | | | N, N, N, A | 8^{th} PUCCH |
| | | | | resource |
| | | | N, N, A, A | 9^{th} PUCCH |
| | | | | resource |
| | | | N, A, N, A | 10^{th} PUCCH |
| | | | | resource |
| | | | A, N, N, A | 11^{th} PUCCH |
| | | | | resource |
| | | | N, A, A, A | 12^{th} PUCCH |
| | | | | resource |
| | | | A, N, A, A | 13^{th} PUCCH |
| | | | | resource |
| | | | A, A, N, A | 14^{th} PUCCH |
| | | | | resource |
| | | | A, A, A, N | 15^{th} PUCCH |
| | | | | resource |

In this table, up to 15 orthogonal PUCCH resources are defined for combinations of up to 4 TBs. TB1 is first transmitted, then followed by TB2, by TB3, by TB4. Or counter Downlink Assignment Index (DAI) is used, TB is associated with DAI index. In the table, A means ACK, N means NACK or discontinuous transmission (DTX).

In the table, for the same PUCCH resource, if one more TB is scheduled, NACK bit is appended on top of existing HARQ feedback. Taking the 1st PUCCH resource for an example, the HARQ feedback bit or bits are N for TB1, (N,N) for (TB1, TB2), (N,N,N) for (TB1, TB2, TB3), and (N,N,N,N) for (TB1, TB2, TB3, TB4).

Such mapping has a benefit that if the last scheduled TB is DTX, i.e, the PDCCH is missed for that TB, gNB could detect this error autonomously. For example, three TBs are scheduled by gNB, but the last TB was missed by UE. If UE reports (N,A) with the 2^{nd} PUCCH resource, the gNB would detect the 2nd PUCCH resource and thus know that the third TB is not corrected received by UE as well.

At 1105, UE may transmit the HARQ feedback report including the HARQ feedback bits using the selected PUCCH resource set.

The maximum number of TBs to be supported for this operating mode is 4 TBs. When the number of the scheduled TBs is greater than 4, UE may report only the HARQ feedback bits for the first scheduled 4 TBs. For a second option, UE may consider this as an error case and uses the 16th PUCCH resource for feeding back. For a third option, the operating mode is switched to ACK/NACK based HARQ feedback, i.e., UE may generate the HARQ feedback report by transforming the NACK only based HARQ feedback bits into ACK/NACK based HARQ feedback bits. For a fourth option, UE doesn't expect to be scheduled with more than 4 TBs, i.e., the BS shall not schedule more than 4 TBs for the NACK only based feedback.

This mode of using a predefined mapping rule for NACK only based HARQ feedback for multicast may support only one G-RNTI or more than one G-RNTI. Different numbers of G-RNTIs to be supported will lead to different HARQ-ACK bits to PUCCH resource mapping.

According to some aspects, UE doesn't expect to be configured with more than one G-RNTI with NACK-only based HARQ feedback in this mode. That is to say, BS shall configure at most one G-RNTI for NACK-only based HARQ feedback in this mode for a UE.

According to other aspects, UE may support at most two G-RNTIs for the NACK only based HARQ feedback for multicast. In this case, each G-RNTI is associated with two TBs, as shown in Table 2 below.

TABLE 2

| HARQ-ACK feedback | | | | |
|---|---|---|---|---|
| | | G-RNTI2 | | |
| G-RNTI1 | | | TB1, TB2, | PUCCH |
| TB1 | TB1, TB2 | TB1, TB2, TB3 | TB3, TB4 | resource |
| N | N, N | N, N, N | N, N, N, N | 1^{st} PUCCH |
| | | | | resource |
| | N, A | N, A, N | N, A, N, N | 2^{nd} PUCCH |
| | | | | resource |
| | A, N | A, N, N | A, N, N, N | 3^{rd} PUCCH |
| | | | | resource |
| | | N, N, A | N, N, A, N | 4^{th} PUCCH |
| | | | | resource |
| | | N, A, A | N, A, A, N | 5^{th} PUCCH |
| | | | | resource |
| | | A, N, A | A, N, A, N | 6^{th} PUCCH |
| | | | | resource |
| | | A, A, N | A, A, N, N | 7^{th} PUCCH |
| | | | | resource |
| | | | N, N, N, A | 8^{th} PUCCH |
| | | | | resource |
| | | | N, N, A, A | 9^{th} PUCCH |
| | | | | resource |
| | | | N, A, N, A | 10^{th} PUCCH |
| | | | | resource |
| | | | A, N, N, A | 11^{th} PUCCH |
| | | | | resource |
| | | | N, A, A, A | 12^{th} PUCCH |
| | | | | resource |
| | | | A, N, A, A | 13^{th} PUCCH |
| | | | | resource |
| | | | A, A, N, A | 14^{th} PUCCH |
| | | | | resource |
| | | | A, A, A, N | 15^{th} PUCCH |
| | | | | resource |

In this table, a first G-RNTI of the two G-RNTIs having a lower index (G-RNTI1) is associated with the first two TBs of the 4 scheduled TBs, and a second G-RNTI of the two G-RNTIs having a higher index (G-RNTI2) is associated with the last two TBs of the 4 scheduled TBs.

Alternatively, gNB may configure the TBs' association with G-RNTIs. UE may receive the configuration of G-RNTI's association with TBs from the base station. If the UE device receives only PDSCH associated with one G-RNTI, the UE reports ACK bits for one or more TBs associated with another G-RNTI.

According to yet other aspects, UE may support more than two G-RNTIs for the NACK only based HARQ feedback for multicast. In this case, UE may generate the HARQ feedback report by transforming the NACK only based feedback bits into ACK/NACK based HARQ feedback bits, i.e., falling back into the mode of transforming NACK-only based HARQ bits into ACK/NACK based HARQ bits.

To determine the total number of HARQ-ACK bits for either of the above two modes, Downlink Assignment Index (DAI) field is used for counting the number of scheduled PDSCH. gNB may communicate to UE the DAI in DCI.

In some aspects, the DAI may have two bits for NACK only based HARQ feedback. The HARQ feedback bits may have a total number same as a value of the DAI.

In other aspects, the DAI may have four bits for NACK only based HARQ feedback. Two most significant bits (MBS) of the four bits are used as a counter DAI which indicates a count of scheduled PDSCHs for current G-RNTI, and two least significant bits (LBS) of the four bits are used a total DAI which indicates a total count of scheduled PDSCHs for all G-RNTIs. The HARQ feedback bits may have a total number same as a value of the total DAI.

The number of bits the DAI includes may be defined as follows. It may include 4 bits if more than one serving cell are configured in the DL for multicast and the higher layer parameter pdsch-HARQ-ACK-Codebook-Multicast indicates dynamic, where the 2 MSB bits are the counter DAI and the 2 LSB bits are the total DAI. It may include 2 bits if only one serving cell is configured in the DL for multicast and the higher layer parameter pdsch-HARQ-ACK-Codebook-Multicast indicates dynamic, where the 2 bits are the counter DAI. Otherwise, it includes 0 bits.

A special domain bundling in a slot can be applied to the above modes for the NACK only based HARQ feedback for multicast to reduce the reported HARQ-ACK bits overhead. For example, HARQ bits for TB1 and TB2 in DCI Format 4_2 are bundled together, i.e., AND operation is applied. In this case, the UE device may support the NACK only based HARQ feedback for multicast for up to 8 scheduled TBs.

Embodiments contemplated herein include an apparatus comprising means to perform one or more elements of one or more methods as discussed above. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of one or more methods as above. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of one or more methods as above. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of one or more methods as above. This apparatus may be, for example, an apparatus of a UE (such as a wireless device 202 that is a UE, as described herein).

Embodiments contemplated herein include a signal as described in or related to one or more elements of the one or more methods as above.

Embodiments contemplated herein include a computer program or computer program product comprising instructions, wherein execution of the program by a processor is to cause the processor to carry out one or more elements of one or more methods as above. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of one or more methods as above. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of one or more methods as above. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of one or more methods as above. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of one or more methods as above. This apparatus may be, for example, an apparatus of a base station (such as a network device 218 that is a base station, as described herein).

Embodiments contemplated herein include a signal as described in or related to one or more elements of one or more methods as above.

Embodiments contemplated herein include a computer program or computer program product comprising instructions, wherein execution of the program by a processing element is to cause the processing element to carry out one or more elements of one or more methods as above. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1-11. (canceled)

12. A user equipment (UE) device, comprising:
at least one antenna;
at least one radio, coupled to the at least one antenna and configured to perform wireless communication using at least one radio access technology; and
one or more processors coupled to the at least one radio, wherein the one or more processors are configured to cause the UE device to:
report to a base station the UE device's capability that supports an operating mode of transforming Non-Acknowledge (NACK) only based Hybrid Automatic Repeat Request (HARQ) feedback bits into Acknowledgement (ACK)/NACK based HARQ feedback bits to support more than one bit for the NACK only based HARQ feedback for multicast;
receive from the base station information on a codebook type for the NACK only based HARQ feedback for multicast configured for the operating mode; and
construct a codebook for the NACK only based HARQ feedback for multicast in a same way as a codebook for the ACK/NACK based HARQ feedback for multicast according to the configured codebook type.

13. The UE device according to claim 12, wherein the codebook type is configured according to one of the following:
1) selectively determining a semi-static codebook or a dynamic codebook for the NACK only based HARQ feedback for multicast;
2) determining the codebook type for the NACK only based HARQ feedback for multicast as same as a codebook type for the ACK/NACK based HARQ feedback for multicast having a same priority;
3) determining the codebook type for the NACK only based HARQ feedback for multicast as same as a codebook type for an HARQ-ACK feedback for unicast Physical Downlink Shared Channel (PDSCH) having a same priority; or
4) combination of 1), 2) or 3).

14. The UE device according to claim 12, wherein the codebook type for the NACK only based HARQ feedback for multicast is configured as a dynamic codebook by default by the UE device.

15. The UE device according to claim 12, wherein the one or more processors are further configured to cause the UE device to:
receive from the base station configuration of a Physical Uplink Control Channel (PUCCH) resource, wherein the PUCCH resource includes a PUCCH resource set for the NACK-only based HARQ feedback for multicast and a PUCCH resource set for the ACK/NACK based HARQ feedback for multicast.

16. The UE device according to claim 12, wherein the one or more processors are further configured to cause the UE device to:
receive from the base station configuration of a Physical Uplink Control Channel (PUCCH) resource; and
determines a PUCCH resource set for ACK/NACK based HARQ feedback for multicast to be used for the NACK-only based HARQ feedback for multicast, according to the configuration of PUCCH resource.

17. The UE device according to claim 16, wherein the determining comprises receiving a separate PUCCH Configuration parameter for NACK-only based HARQ feedback for multicast, or receiving a Radio Resource Control (RRC) signaling including a PUCCH configuration for ACK/NACK based HARQ feedback for multicast.

18. The UE device according to claim 12, wherein the one or more processors are further configured to cause the UE device to:
apply a Physical Uplink Control Channel (PUCCH) configuration for unicast to the NACK-only based HARQ feedback for multicast.

19. (canceled)

20. A user equipment (UE) device, comprising:
at least one antenna;
at least one radio, coupled to the at least one antenna and configured to perform wireless communication using at least one radio access technology; and
one or more processors coupled to the at least one radio, wherein the one or more processors are configured to cause the UE device to:
report to a base station the UE device's capability that supports an operating mode of a using a predefined mapping rule which defines mapping between one or more Hybrid Automatic Repeat Request (HARQ) feedback bits for respective received one or more Transport Blocks (TBs) and a plurality of Physical Uplink Control Channel (PUCCH) resource sets to support more than one bit for Non-Acknowledge (NACK) only based HARQ feedback for multicast;
receive, from the base station, a Radio Resource Control (RRC) signaling which indicates a PUCCH configuration for the NACK only based HARQ feedback for multicast;
generate an HARQ feedback report which includes HARQ feedback bits comprising an ACK or NACK bit for each scheduled TB;
select a PUCCH resource set from the plurality of PUCCH resource sets according to the predefined mapping rule, wherein for a particular PUCCH resource set in the predefined mapping rule, if one more TB is scheduled, a NACK bit is appended on top of one or more existing HARQ feedback bits; and
transmit the HARQ feedback report using the selected PUCCH resource set.

21. The UE device according to claim 20, wherein the NACK bit indicates NACK or discontinuous transmission (DTX).

22. The UE device according to claim 20, wherein the UE device supports the NACK only based HARQ feedback for multicast for up to 4 scheduled TBs.

23. The UE device according to claim 22, wherein when a number of the scheduled TBs is greater than 4, the one or more processors are further configured to cause the UE device to perform one of the following:
reporting the HARQ feedback bits for the first scheduled 4 TBs;
reporting an error by using an additional PUCCH resource set other than the plurality of PUCCH resource sets;
generating the HARQ feedback report by transforming the NACK only based HARQ feedback bits into ACK/NACK based HARQ feedback bits.

24. The UE device according to claim 22, wherein the one or more processors are further configured to cause the UE device to support one Group-Radio Network Temporary Identifier (G-RNTI) for the NACK only based HARQ feedback for multicast.

25. The UE device according to claim 22, wherein the one or more processors are further configured to cause the UE device to support at most two Group-Radio Network Temporary Identifiers (G-RNTIs) for the NACK only based HARQ feedback for multicast, and wherein each G-RNTI is associated with two TBs.

26. The UE device according to claim 25, wherein a first G-RNTI of the two G-RNTIs having a lower index is associated with the first two TBs of the 4 scheduled TBs, and a second G-RNTI of the two G-RNTIs having a higher index is associated with the last two TBs of the 4 scheduled TBs.

27. The UE device according to claim 25, wherein the one or more processors are further configured to cause the UE device to receive a configuration of G-RNTI's association with TBs from the base station.

28. The UE device according to claim 27, wherein the one or more processors are further configured to cause the UE device to:
if the UE device receives only a Physical Downlink Shared Channel (PDSCH) associated with one G-RNTI, report ACK bits for one or more TBs associated with another G-RNTI.

29. The UE device according to claim 22, wherein the one or more processors are further configured to cause the UE device to support more than two Group-Radio Network Temporary Identifiers (G-RNTIs) for the NACK only based HARQ feedback for multicast, and generate the HARQ feedback report by transforming the NACK only based feedback bits into ACK/NACK based HARQ feedback bits.

30. The UE device according to claim 20, wherein the one or more processors are further configured to cause the UE device to receive a Downlink Assignment Index (DAI) in Downlink Control Information (DCI), wherein the DAI has two bits and indicates a count of scheduled Physical Downlink Shared Channels (PDSCHs), and wherein the HARQ feedback bits have a total number same as a value of the DAI.

31. The UE device according to claim 20, wherein the one or more processors are further configured to cause the UE device to receive a Downlink Assignment Index (DAI) in Downlink Control Information (DCI), wherein the DAI has four bits, two most significant bits (MBS) of which indicate a count of scheduled Physical Downlink Shared Channels (PDSCHs) for current Group-Radio Network Temporary Identifiers (G-RNTI), two least significant bits (LBS) of which indicate a total count of scheduled PDSCHs for all G-RNTIs, and wherein the HARQ feedback bits have a total number same as a value of the total count.

32. The UE device according to claim 20, wherein the one or more processors are further configured to cause the UE device to perform a special domain bundling in a slot on the generated HARQ feedback bits, and wherein the UE device supports the NACK only based HARQ feedback for multicast for up to 8 scheduled TBs.
